(19) United States
(12) Patent Application Publication
(10) Pub. No.: US 2004/0056054 A1
(43) Pub. Date: Mar. 25, 2004

(54) Medicament dispenser with electropolished surfaces

(76) Inventor: David Michael Ottolangui, Hertfordshire (GB)

Correspondence Address: DAVID J LEVY, CORPORATE INTELLECTUAL PROPERTY, GLAXOSMITHKLINE, FIVE MOORE DR., PO BOX 13398, RESEARCH TRIANGLE PARK, NC, 27709-3398, US

(21) Appl. No.: 10/451,037

(22) PCT Filed: Nov. 20, 2001
(86) PCT No.: PCT/EP01/13422

(30) Foreign Application Priority Data
Dec. 21, 2000 (GB) 0031176.1

(51) Int. Cl. B67D 3/00

(52) U.S. Cl. 222/544

(57) ABSTRACT

There is provided a dispenser for dispensing a medicament in a fluid propellant comprising a reservoir for housing the medicament and a drug-dispensing mechanism. The drug-dispensing mechanism may be a valve made wholly or substantially of metal. The metal surfaces of the reservoir and/or valve have been finished by electropolishing. The finished surfaces of the reservoir and/or valve reduce the tendency of drug to adhere thereto.

### FIELD OF INVENTION

The present invention relates to inhalation devices for dispensing medicaments to patients. More especially, the invention relates to a metered dose inhaler for consistently dispensing a prescribed dose of medicament.

### BACKGROUND TO THE INVENTION

Drugs for treating respiratory and nasal disorders are frequently administered in aerosol formulations through the mouth or nose. One widely used method for dispensing such aerosol drug formulations involves formulating the drug as a suspension or a solution in a liquefied gas propellant. The suspension/solution is stored in a sealed reservoir or canister capable of withstanding the pressure required to maintain the propellant as a liquid. The suspension/solution is dispersed by activation of a valve, sometimes in the form of a metering valve, affixed to the canister.

Medicaments for treating respiratory disorders are also administered as dry powder formulations through the mouth and nose. Dry powder inhalation (DPI's) devices, or inhalers, are used in the administration of these drugs, inhalation by the patient resulting in uptake of a specified dosage of medicament through the nose or mouth. The drug may be stored as a dry powder within a reservoir in the body of the inhaler, a metering chamber being utilized to administer a specified dose of medicament. Alternatively, more sophisticated inhalation devices employ medicament carriers, such as individual capsules or blister packs/strips containing defined doses of powdered drug.

A metering valve generally comprises a metering chamber that is of a set volume and is designed to administer per actuation an accurate predetermined dose of medicament. Metering valves are used in inhalation devices which deliver dry powder, aerosol and liquid formulations of drugs. In principle, metering valves operate in a similar manner in each of these devices, as described for aerosol based drug dispensers below.

As the suspension/solution is forced from the canister through the dose metering valve by the high vapour pressure of the propellant, the propellant rapidly vaporises leaving a fast moving cloud of very fine particles of the drug formulation. This cloud of particles is directed into the nose or mouth of the patient by a channelling device such as a cylinder or open-ended cone. Concurrently with the activation of the aerosol dose metering valve, the patient inhales the drug particles into the lungs or nasal cavity. Systems of dispensing drugs in this way are known as “metered dose inhalers” (MDI's). See Peter Byron, Respiratory Drug Delivery, CRC Press, Boca Raton, Fla. (1990) for a general background on this form of therapy.

Patients often rely on medication delivered by inhalation devices for rapid treatment of respiratory disorders which are debilitating and in some cases even life threatening. Therefore, it is essential that the prescribed dose of medication delivered to the patient consistently meet the specifications claimed by the manufacturer and comply with the requirements of the FDA and other regulatory authorities. That is, every dose in the can must be capable of delivery within the same close tolerances.

A phenomenon which can exist with drug delivery devices, such as conventional aerosol/MDI's, DPI's and/or liquid dispensers, is the deposition of the medicament, or a solid component in the form of powder or particulates from a suspension of the product in a liquid, onto the internal surfaces of the device. Chemical deposition within the canister, metering chamber and on the valve stem of inhalation devices may cause problems in their operation.

One problem which can occur through the deposition of medicament and/or formulation/propellant additives onto the internal surfaces of the metering chamber of inhalation devices, is a reduction in their efficacy and of the resulting treatment for the patient. The deposition of the product reduces the amount of the active drug available to be dispensed to the patient and markedly affects the uniformity of the dose dispensed during the lifetime of the device.

Another problem which may arise through drug or formulation/propellant additive deposition onto the surfaces of valves used in inhalation devices in that the valve stem may stick, pause, or drag during the actuation cycle. The result of such sticking is that the user perceives a ‘notchiness’ as the valve stem is depressed and released due to the presence of chemical deposits on the sliding interface creating increased friction during operation.

The deposition of medicament and formulation/propellant additives may also occur on the internal surfaces of the drug reservoir, such as the canister of MDI devices. Again this may impair the operation and effective lifetime of the device by reducing both the amount of active ingredient available for administration and the uniformity of the dose dispensed.

The problem of drug deposition in conventional aerosols and MDI's is exacerbated when excipient-free aerosol formulations are used based on the hydrofluoroalkane (HFA) propellants 134a and 227. It has also been found that drug deposition increases with storage of the aerosol, particularly when the aerosol is stored at high temperatures and/or high humidity.

It is an object of the present invention to provide inhalation devices with improved smoothness of operation with alleviates the problem of valve sticking and which consistently deliver uniform doses of medicament.

A key factor in determining the extent of chemical deposition to the internal surfaces of inhalation devices in the topography of their internal surfaces, particularly of the valve. At a microscopic level these surfaces are not smooth but are pitted and burred in nature, comprising may extraneous edges where drug adhesion and deposition may take place.

The existence of such burred and pitted surfaces may pose additional problems with regards to the increased frictional properties of the valve. Furthermore, the uneven nature of the surfaces may present difficulties for covering the valve with friction-reducing coatings. Thus, for example, the adhesion of friction-reducing coatings, such as fluoropolymers, to the valve surface may be impaired by the presence of such burred and pitted surfaces.

Some prior art devices rely on the dispenser being shaken so as to agitate the formulation/propellant and product mixture therein, in an attempt to dislodge the deposited particles. However, while in some cases this remedy can be effective within the body of the drug container itself, it may not be effective for particles deposited on the inner surfaces of other dispenser components such as those of the metering valve.

The Applicants have found that the aforementioned problem of drug adherence and dose uniformity can be greater when the surfaces (especially the internal surfaces) are substantially comprised of a metal, such as stainless steel. However, the Applicants have now found that by treating the surfaces of the device by a process of electropolishing, the problem of surface pitting and burred is ameliorated. Drug deposition is thereby reduced resulting in greater dose uniformity and smoother operation over the lifetime of the device. Furthermore, the reduction of surface pitting and burring also improves the frictional properties of the metering valve and produces a more uniform foundation for covering with friction-reducing coatings. In addition, electropolishing may be used to clean surfaces of artefacts of the manufacturing process, such as grease and oil.

International patent application WO 99/55600 addresses the problem of drug adhesion and deposition onto the surfaces, especially the internal surfaces, of inhalation devices. The patent application describes the use of bright annealing to reduce surface burrs on the side port of a metering valve stem of an inhalation device. The application also discloses the use of acid treatment and barrelling to improve the surface properties of the valve stem. Bright annealing is a complex, multi-stage process involving treatment at extremely high temperatures under controlled chemical conditions (e.g. hydrogen and/or nitrogen atmospheres) in specially designed furnaces. In contrast, the electropolishing process described in the present invention is a simpler, less expensive and more easily controllable means for treating the surfaces of inhalation devices.

U.S. Pat. No. 4,4884,708 describes the use of electrochemical polishing of the internal surfaces of metallic pressure vessels to reduce contamination of storage gases. The roughness of the interior surface of such vessels is known to be a direct factor in maintaining the purity and stability of storage gases within these vessels. The process of electrochemical polishing drastically reduces the active area or profile of the interior surfaces thereby ameliorating the problem.

U.S. Pat. No. 5,326,078 discloses the use of multi-stage electropolishing of a casing bed and valve seat of a diaphragm valve, principally for use in valves in fluid pipings of semi-conductor producing equipment. The technique is employed to reduce the extent of undrained fluids which may remain within the ‘dead zone’ of the casing bed. The patent only describes electropolishing of those components of the valve.

U.S. Pat. No. 5,740,792 concerns inhalation devices and discloses a reservoir plug comprising a thin plate of electropolished stainless steel. The purpose of electropolishing is to provide a very flat, smooth and rigid surface which can form a leak-proof seal with a dosing plate in the device. No mention is made of the problems associated with drug adherence and deposition to the surfaces of the inhalation device nor of the use of electropolishing in addressing these problems.

### SUMMARY OF INVENTION

According to one aspect of the present invention there is provided a dispenser for dispensing a medicament in a formulation comprising a reservoir for housing the medicament; and a drug-dispensing mechanism, wherein the surfaces of the reservoir and/or the mechanism comprise a conductive or semi-conductive material having an electropolished finish. For example, those surfaces of the reservoir and the mechanism which come into contact with the medicament formulation, and those surfaces of the mechanism which come into frictional contact with other surfaces within the dispenser, have an electropolished finish. In particular, the internal surfaces of the reservoir and the surface components of the mechanism (such as a valve stem) have an electropolished finish.

Electropolishing, also known as electrochemical polishing or electrolytic polishing, can be conducted by any means known in the art. Generally, electropolishing involves coating the conductive substrate material with an electrolytic material. The electrolytic material forms a polarising film upon the surface of the substrate. The coated substrate is exposed to an electric current, causing the conductive substrate material to anodically dissolve, thus removing any ‘high spots, burrs or edges’ of residual material on the conductive substrate and leaving a smooth surface on the conductive substrate material.

The electrolytic material can be any solid, liquid or gas material suitable for forming an anodic highly polarised film on the metal that reacts with newly formed metal ions to dissolve them. Representative examples of suitable electropolishing solutions include phosphoric acid, sulphuric acid and cyanide solutions. Practical electropolishing baths provide an anode film that is nearly saturated with the salt of the dissolving metal at a current density that maintains the conditions.

The quantity of metal removed from the conductive substrate material is proportional to the amount of current applied and the time. Other factors, such as the geometry of the substrate material, affect the distribution of the current and, consequently, have an important bearing upon the amount of metal removed in local areas.

The principle of differential rates of metal removal is important to the concept of ‘smoothing’ or ‘deburring’ accomplished by electropolishing. Fine edges or burrs become very high current density areas and are, subsequently, rapidly dissolved. Low current density areas receive lesser amounts of current and may show negligible metal removal.

In the course of electropolishing, the substrate material is manipulated to carefully control the amount of metal removal so that polishing is accomplished and, at the same time, dimensional tolerances are maintained. Electropolishing literally dissects the metal crystal atom by atom, with rapid attack on the high current density areas and lesser attack on the low current density areas. The result is an overall reduction of the surface profile with a simultaneous smoothing and brightening of the metal surface.

In the case of stainless steel alloys, an important effect is caused by differences in the rates of removal of the components of the alloy. For example, iron and nickel atoms are more easily extracted from the crystal lattice than are chromium atoms. The electropolishing process removes the iron and nickel preferentially, leaving an enhanced surface layer consisting of corrosion-resistant chromium oxide. This phenomenon imparts the important property of “passivation” to electropolished surfaces.

In one aspect, the conductive material comprises a metal. Preferably the metal is selected from the group consisting of stainless steel, aluminum, iron, copper, tin, chromium, nickel and any alloys thereof.

In another aspect, the semi-conductive material comprises silicon.

In one aspect, the drug-dispensing mechanism and/or the reservoir is/are made wholly of metal.

Preferably, the drug-dispensing mechanism comprises a valve. More preferably the valve is a metering valve. Preferably all the surfaces exposed to frictional contact within the metering valve, such as the valve stem, together with the internal surfaces of the metering chamber which come into contact with the medicament formulation, have an electropolished finish.

In one aspect, the surfaces of the valve comprise a friction-reducing coating. Preferably, the coating is selected from the group consisting of silicon oil, organic polymeric oil and mixtures thereof.

Preferably the coating comprises a polymeric material. More preferably, the polymeric material is selected from a fluoropolymer and a copolymer of a fluoropolymer with another polymer.

Suitable fluoropolymers include polytetrafluoroethylene (PTFE), ethylenetetrafluoroethylene (ETFE), polyvinyldienefluoride (PVDF), perfluoroalkoxyalkane (PFA), polyvinylfluoride (PVF), polychlorotrifluoroethylene (PCTFE) and fluorinated ethylenepropylene (FEP). Fluorocarbon polymers are marketed under trademarks such as Teflon®, Tefzel®, Halar® and Hostaflon®, Polyflon® and Neoflon®. Grades of polymer include FEP DuPont 856-200, PFA DuPont 857-200, PTFE-PES DuPont 3200-100, PTFE-FEP-polyamideimide DuPont 856P23485, FEP powder DuPont 532, and PFA Hoechst 6900n.

Suitable copolymers comprise from 1 to 99%, preferably from 5 to 95% by weight of fluorinated polymer. Suitable copolymers include copolymers of tetrafluoroethylene (TFE) with PFA, TFE with hexafluoropropylene (HFP) (available as FEP 6107 and FEP 100 from DYNEON), VDF with HFP (commercially available as Viton A), TFE with perfluoro(propyl vinyl ether) (available as PFA 6515N from DYNEON), a blend of TFE, hexafluoropropylene and vinylidene fluoride (available commercially as THV 200G from DYNEON), HOSTAFORM X329TM (Hoechst) which is a 5% PTFE/Acetal blend, HOSTAFORM C9021TF which is a 20% PTFE/Acetal blend, PTFE/PBT blends (for example, LNP WL4040), and PTFE/PBT/silicone blends (for example, LNP WL4540).

Other suitable coatings comprise cross-linked fluorinated polymers. In one aspect, the treated surface has one or more fluorocarbon polymers in combination with one or more non-fluorocarbon polymers disposed thereon. In another aspect, the treated surface has a linear, non-cross-linked polymeric compound disposed thereon.

In one aspect, the coating compound comprises a functional grouping which is capable of anchoring the compound to the surface thereof. As a first example, the compound may be an organo-phosphate such as a phosphate based perfluoroether derivative. As a second example, the compound may be an organo-silane derivative such as a silane derivative of perfluoropolyoxyalkane e.g. a silane derivative of perfluoropolyoxyalkane having a molecular weight in the range of 1600-1750.

Typically, the compound is a phosphoric ester.

In one embodiment, the coating compound comprises the general formula:

R¹—(CH₂)ᵥ—CF₂O—(C₂F₄O)ₓ—(CF₂O)_{y}CF₂—(CH₂)_{w}—R¹ (I)

wherein R¹ comprises:

—(OCH₂—CH₂)_{z}—OPO(OH)₂, wherein x, y and z are such the molecular weight of the compound is 900-2100 and v and w independently represent 1 or 2.

In one preferred embodiment, v and w are both 1. In a second preferred embodiment v and w are both 2.

Compounds of formula (I) will generally be employed as mixtures, the nature of which may be varied as part of optimization of the employment of the invention.

The synthesis of compounds of formula (I) may readily be determined by reference to EPO 687 533 which describes similar compounds.

In another embodiment, the coating compound has the general formula:

R²—(OC₃F₆)ᵣ—(OCF₂)ₜ—R³ (II)

Wherein R² comprises a fluoro-alkyl functional group;

r and t are such that the molecular weight of the compound is 350-1000; and

R³comprises a phosphoric ester functional group.

Whilst not wishing to be bound by any theory, it is believed that the anchoring (e.g. phosphate) moiety of the compounds of formulas (I) and (II) reacts with the surface of the component to anchor the compound to the surface. Thus, when in use, the per-fluorinated end of the compound is presented to the pharmaceutical formulation and so provides a highly fluorinated surface.

Further embodiments include perfluoropolyethers having functional groups of the type —CONR₄R₅ wherein R₄ and R₅ may be independently selected from hydrogen, or a silyl ether (e.g. SiRₘ(OR)₃₋ₘ wherein R=hydrogen or C₁₋₈ alkyl and m=0 to 2) as disclosed in U.S. Pat. No. 4,746,550 which is incorporated herein by reference. Methods of preparing polymeric compounds of the type described above may readily be determined by reference the aforementioned US patent.

Other suitable coatings include siloxanes such as dimethyl siloxane which in one aspect, may be applied by plasma polymerisation processes.

Fluorine-containing polymers may be blended with non-fluorinated polymers such as polyamides, polyimides, polyethersulfones, polyphenylene sulfides, and amineformaldehyde thermosetting resins to give blended coatings. These added polymers improve adhesion of the polymer coating to the valve. Preferred polymer blends are PTFE/FEP/polyamideimide, PTFE/polyether sulphone (PES) and FEP-benzoguanamine.

Particularly preferred coatings are blends of PTFE and polyethersulphone (PES).

The surface of the valve may be coated by any means known in the art of metal coating. For example, metal parts may be pre-coated as coil stock and cured before being stamped or drawn into the valve shape.

Other suitable coating techniques include electrostatic dry powder coating or by spraying pre-formed valves inside with formulations of the coating with optional curing. The valve may also be dipped in the coating formulation and cured, thus becoming coated on the inside and out. The coating formulation may also be poured inside the valve then drained out leaving the insides coated. The coating may also be formed in situ at the valve using plasma polymerisation as described below.

Coating and optional curing conditions may be varied to suit the particular coating type. For coil coating and spray coating temperatures in excess of the melting point of the polymer are typically required, for example, about 50° C. above the melting point for up to about 20 minutes such as about 5 to 10 minutes e.g. about 8 minutes or as required. For the above named preferred and particularly preferred polymer blends curing temperatures in the range of about 300° C. to about 400° C., e.g. about 350° C. to 380° C. are suitable.

One suitable means of applying a fluorine-containing coating is by plasma coating, for example, by a CF₄ or fluorine ion plasma coating technique. The plasma coating may consist of a fluorinated polymer laid down on the surface of the valve component, preferably the chamber, by polymerisation or by modification of a hydrocarbon-containing pre-coating on the surface by interchange of hydrogen ions in the material with fluorine ions. The coating process typically takes place in a vacuum at ambient temperature. The components to be coated are placed inside a chamber which is evacuated. The fluorine monomer or fluorine source is introduced into the chamber at a controlled rate. The plasma is ignited within the chamber and maintained for a given time at a chosen power setting. For plasma polymerisation typically temperatures in the range of about 20° C. to about 100° C. may be employed. At the end of the treatment the plasma is extinguished, the chamber flushed and the products retrieved. In the polymerisation process, a thin layer of plasma polymer will be bonded to the valve.

The coating thickness is in the range of about 1 μm to about 1 mm. Suitably the coating thickness is in the range of about 1 μm to about 100 μm, e.g. 1 μm to 25 μm. Coatings may be applied in one or more coats.

The term “metered dose inhaler” or “MDI” means a unit comprising a reservoir such as a canister, a crimped cap covering the mouth of the reservoir, a drug metering valve situated in the cap, a metering chamber and a suitable channelling device into which the canister is fitted. The term “drug metering valve” or “MDI valve” refers to a valve and its associated mechanisms which delivers a predetermined amount of drug formulation from an MDI upon each activation. The channelling device may comprise, for example, an actuating device for the valve and a cylindrical or cone-like passage through which medicament may be delivered from the filled MDI can via the MDI valve to the nose or mouth of a patient, e.g. a mouthpiece actuator. The relation of the parts of a typical MDI is illustrated in U.S. Pat. No. 5,261,538.

Preferably, the reservoir and/or the valve are made of stainless steel or aluminum. The advantages of incorporating a metal drug metering valve and reservoir/canister include the ability to exert tighter control on component tolerances during manufacture. In addition, studies have found that a conducting component surface that is treated to have a defined surface energy facilitates dose uniformity. Therefore, if the reservoir and the valve are substantially made of metal or metal alloys, almost the entire MDI can be conducting and contribute towards the maintenance of a consistent dose.

Optionally, a moisture absorbing means may be comprised within the dispenser herein as a component thereof. Alternatively, the moisture absorbing means may be a separate component of the formulation contained within the dispenser.

The moisture absorbing means may comprise a component or accessory for use with a reservoir/canister or valve that is made from a plastics material which is a natural desiccant, such as a polyamide, for example nylon, or may be moulded from other plastics material such as Acetal or PBT and include a desiccant such as a molecular sieve and silica gel. Alternatively, or in addition, the moisture absorbing means may comprise an internal lining or coating. In one embodiment, the moisture absorbing means may be incorporated into a treatment or coating for reservoirs/canisters and/or valves for preventing drug deposition and/or maintaining dose uniformity.

Other vapour or moisture absorbing materials include desiccants made from inorganic materials such zeolites and aluminas. Such inorganic materials have high water absorption capacities and favourable water absorption isotherm shapes. The water absorption capacity of such materials typically varies from 20 to 50 weight percent.

Other exemplary moisture absorbing materials include, but are not limited to, alumina, bauxite, anhydrous, calcium sulphate, water-absorbing clay, activated bentonite clay, a molecular sieve, or other like materials.

In conjunction with the desiccant an additional compound may be added to act as a conduit/channelling agent to increase/optimise the efficiency of the moisture absorption properties. Such materials may include compounds such as polyethylene glycols.

Preferably, the means for absorbing moisture reduces the rise in moisture content over time, and/or the decrease in Fine Particulate Mass over time by between 20 and 100%, for example, 40 to 70%, e.g. 45 to 55%.

Typically, the component or accessory takes the form of a cap and/or a seal and/or a lining.

The desiccant should be present in an amount sufficient to absorb any increases in moisture around the valve area of the MDI and thus alleviate or substantially prevent moisture increases inside the reservoir/canister.

Typically, 100 μg to 5 g, for example, 1 mg to 1 g, e.g. 100 mg to 500 mg, such as about 100 mg to 250 mg of desiccant may be included.

Typically, the propellant includes a hydrofluroalkane, for example, at least one of 1,1,1,2-tetrafluoroethane (HFA-134a) and 1,1,1,2,3,3,3-heptafluoropropane (HFA-227). 1,1,1,2-tetrafluoroethane (HFA-134a) is a preferred propellant herein.

Typically, the drug-dispensing valve is a metering valve.

The reservoir (such as a canister) herein optionally comprises moisture absorbing means which takes the form of a crimped cap, and/or coating, and/or treatment, and/or lining, and/or other accessory for sealing the reservoir. The moisture absorbing means may be made of a material which is naturally a desiccant or a plastics material including a desiccant.

Typically, the reservoir contains a pharmaceutical aerosol formulation comprising a medicament and a fluorocarbon propellant.

Conventionally, the reservoirs/canisters and caps for use in MDI's are made of aluminum or an alloy of aluminum although other metals not affected by the drug formulation, such as stainless steel, an alloy of copper, or tin plate, may be used. An MDI reservoir/canister may also be fabricated from glass or plastics. Preferably, however, the MDI reservoirs/canisters are caps employed in the present invention are made of aluminum or an alloy thereof.

The reservoir and any caps or channelling devices herein may be coated with any of the coatings described herein for use as valve coatings.

The canister is preferably a pressurised container comprising an aluminum metal vial having a metering valve disposed therein. While the pressurised container preferably includes a meeting valve, other valve systems are not beyond the scope of the present invention. Other valve systems include, but are not limited to, wedge gate valve systems, double-disc gate valve systems, globe and angle valve systems, swing check valve systems, end cock valve systems, and other like valve systems. Since the pressurised container is preferably part of an MDI, the valve design is typically a function of providing a predetermined dosage or amount of the drug contained within the pressurised container to a user.

The valve typically comprises a valve body having an inlet port through which the pharmaceutical aerosol formulation may enter said valve body, an outlet port through which the pharmaceutical aerosol may exit the valve body and an open/close mechanism by means of which flow through said outlet port is controllable.

The valve may be a slide valve wherein the open/close mechanism comprises a sealing ring and receivable by the sealing ring a valve stem having a dispensing passage, the valve stem being slidably movable within the ring from a valve-closed to a valve-open position in which the interior of the valve body is in communication with the exterior of the valve body via the dispensing passage.

Typically, the valve is a metering valve. The metering volumes are typically from 50 to 100 μl, such as 50 μl or 63 μl. Suitably, the valve body defines a metering chamber for metering an amount of medicament formulation and an open/close mechanism by means of which the flow through the inlet port to the metering chamber is controllable. Preferably, the valve body has a sampling chamber in communication with the metering chamber via a second inlet port, said inlet port being controllable by means of an open/close mechanism thereby regulating the flow of medicament formulation into the metering chamber.

The valve may be a metering valve in which the valve body has a metering chamber, a sampling chamber and therebetween a second sealing ring within which the stem is slidably movable, the valve stem having a transfer passage such that in the valve-closed position the dispensing passage is isolated from the metering chamber and the metering chamber is in communication with the sampling chamber via the transfer passage, and in the valve-open position the dispensing passage is in communication with the metering chamber and the transfer passage is isolated from the metering chamber.

The value may also comprise a ‘free flow aerosol valve’ having a chamber and a valve stem extending into the chamber and moveable relative to the chamber between dispensing and non-dispensing positions. The valve stem has a configuration and the chamber has an internal configuration such that a metered volume is defined therebetween and such that during movement between its non-dispensing and dispensing positions the valve stem sequentially: (i) allows free flow of aerosol formulation into the chamber, (ii) defines a closed metered volume for pressurised aerosol formulation between the external surface of the valve stem and internal surface of the chamber, and (iii) moves with the closed metered volume within the chamber without decreasing the volume of the closed metered volume until the metered volume communicates with an outlet passage thereby allowing dispensing of the metered volume of pressurized aerosol formulation. A valve of this type is described in U.S. Pat. No. 5,772,085.

The valve may also have a structure and action similar to those aerosol valves described in European Patent Application No. EP-A-870,699 and PCT Patent Application No. WO 99/36334.

The sealing ring may be formed by cutting a ring from a sheet of suitable material. Alternatively, the sealing ring may be formed by a moulding process such as an injection moulding, a compression moulding or a transfer moulding process.

Typically, the sealing ring and/or second sealing ring comprise an elastomeric material. The ring is typically resiliently deformable.

The elastomeric material may either comprise a thermoplastic elastomer (TPE) or a thermoset elastomer which may optionally be cross-linked. The sealing ring may also comprise a thermoplastic elastomer blend or alloy in which an elastomeric material is dispersed in a thermoplastic matrix. The elastomers may optionally additionally contain conventional polymer additives such as processsing aids, colorants, tackifiers, lubricants, silica, talc, or processing oils such as mineral oil in suitable amounts.

Suitable thermoset rubbers include butyl rubbers, chloro-butyl rubbers, bromo-butyl rubbers, nitrile rubbers, silicone rubbers, fluorosilicone rubbers, fluorocarbon rubbers, polysulphide rubbers, polypropylene oxide rubbers, isoprene rubbers, isoprene-isobutene rubbers, isobutylene rubbers or neoprene (polychloroprene) rubbers.

Suitable thermoplastic elastomers comprise a copolymer of about 80 to about 95 mole percent ethylene and a total of about 5 to about 20 mole percent of one or more comonomers selected from the group consisting of 1-butene, 1-hexene, and 1-octene as known in the art. Two or more such copolymers may be blended together to form a thermoplastc polymer blend.

Another suitable class of thermoplastic elastomers are the styrene-ethylenel butylene-styrene block copolymers. These copolymers may additionally comprise a polyolefin (e.g. polypropylene) and a siloxane.

Thermoplastic elastomeric material may also be selected from one or more of the following: polyester rubbers, polyurethane rubbers, ethylene vinyl acetate rubber, styrene butadiene rubber, copolyether ester TPE, olefinic TPE, polyester amide TPE and polyether amide TPE.

Other suitable elastomers include ethylene propylene diene rubber (EPDM). The EPDM may be present on its own or present as part of a thermoplastic elastomer blend or alloy, e.g. in the form of particles substantially uniformly dispersed in a continuous thermoplastic matrix (e.g. polypropylene or polyethylene). Commercially available thermoplastic elastomer blend and alloys include the SANTOPRENE™ elastomers. Other suitable thermoplastic elastomer blends include butyl-polyethlene (e.g. in a ratio ranging between about 2:3 and about 3:2) and butyl-polypropylene.

Typically, the sealing ring and/or the second sealing ring additionally comprises lubricant material. Suitably, the sealing ring and/or the second sealing ring comprises up to 30%, preferably from 5 to 20% lubricant material.

In addition, the stem may also comprise lubricant material. Suitably, the valve stem comprises up to 30%, preferably from 5 to 20% lubricant material.

The term ‘lubricant’ herein means any material which reduces friction between the valve stem and seal. Suitable lubricants include silicone oil or a fluorocarbon polymer such as polytetrafluoroethane (PTFE) or fluoroethylene propylene (FEP).

Lubricant can be applied to the stem, sealing ring or a second sealing ring by an suitable process including coating and impregnation, such as by injection or a tamponage process.

In medical use the canisters in accordance with the invention contain a pharmaceutical aerosol formulation comprising a medicament and a fluorocarbon or hydrogen-containing chlorofluorocarbon propellant.

Suitable propellants include, for example, C₁₋₄hydrogen-containing chlorofluorocarbons such as CH₂ClF, CClF₂CHClF, CF₃CHClF, CHF₂CClF₂, CHClFCHF₂, CF₃CH₂Cl and CClF₂CH₃; C₁₋₄hydrogen-containing fluorocarbons such as CHF₂CHF₂, CF₃CH₂F, CHF₂CH₃ and CF₃CHFCF₃; and perfluorocarbons such as CF₃CF₃ and CF₃CF₂CF₃.

Where mixtures of the fluorocarbons or hydrogen-containing chlorofluorocarbons are employed they may be mixtures of the above identified compounds or mixtures, preferably binary mixtures, with other fluorocarbons or hydrogen-containing chlorofluorocarbons for example CHClF₂, CH₂F₂ and CF₃CH₃. Preferably a single fluorocarbon or hydrogen-containing chlorofluorocarbon is employed as the propellant. Particularly preferred as propellants are C₁₋₄hydrogen-containing fluorocarbons such as 1,1,1,2-tetrafluoroethane (CH₃CH₂F) and 1,1,1,2,3,3,3-heptafluoro-n-propane (CF₃CHFCF₃) or mixtures thereof.

The pharmaceutical formulations for use in the canisters of the invention contain no components which provoke the degradation of stratospheric ozone. In particular the formulations are substantially free of chlorofluorocarbons such as CCl₃F, CCl₃F₂ and CF₃CCl₃.

The propellant may additionally contain a volatile adjuvant such as a saturated hydrocarbon for example propane, n-butane, isobutane, pentane and isopentane or a dialkyl ether for example dimethyl ether. In general, up to 50% w/w of the propellant may comprise a volatile hydrocarbon, for example 1 to 30% w/w. However, formulations which are free of substantially free of volatile adjuvants are preferred. In certain cases, it may be desirable to include appropriate amounts of water, which can be advantageous in modifying the dielectric properties of the propellant.

The invention is particularly useful with propellants (including propellant mixtures) which are more hygroscopic than P11, P114 and/or P12 such as HFA-134a and HFA-227.

A polar co-solvent such as C₂₋₆ aliphatic alcohols and polyols e.g. ethanol, isopropanol and propylene glycol, preferably ethanol, may be included in the drug formulation in the desired amount to improve the dispersion of the formulation, either as the only excipient or in addition to the excipients such as surfactants. Suitably, the drug formulation may contain 0.01 to 5% w/w based on the propellant of a polar co-solvent e.g. ethanol, preferably 0.1 to 5% w/w e.g. about 0.1 to 1% w/w. In aspects herein, the solvent is added in sufficient quantities to solubilise the part of all of the medicament component, such formulations being commonly referred to as solution formulations.

A surfactant may also be employed in the aerosol formulation. Examples of conventional surfactants are disclosed in EP-A-372,777. The amount of surfactant employed is desirable in the range 0.0001% to 50% weight to weight ratio relative to the medicament, in particular, 0.05 to 5% weight to weight ratio. Preferred surfactants are lecithin, oleic acid and sorbitan trioleate. Preferred formulations, however, are free or substantially free of surfactant.

Pharmaceutical formulations may contain 0.0001 to 50% w/w, preferably 0.001 to 20%, for example 0.001 to 1% of sugar relative to the total weight of the formulation. Generally the ratio of medicament to sugar falls within the range of 1:0.01 to 1:100 preferably 1:0.1 to 1:10. Typical sugars which may be used in the formulations include, for example, sucrose, lactose and dextrose, preferably lactose, and reducing sugars such as mannitol and sorbitol, and may be in micronised or milled form.

The final aerosol formulation desirably contains 0.005-10% w/w, preferably 0.005 to 5% w/w, especially 0.01 to 1.0% w/w, of medicament relative to the total weight of the formulation.

In one aspect, the dispenser is suitable for dispensing medicament in a dry powder formulation.

In another aspect, the dispenser is suitable for dispensing medicament in an aqueous formulation.

In another aspect of the present invention, there is provided a drug-dispensing valve for use in a dispenser for dispensing a medicament in a formulation, wherein the surfaces of the valve comprise a conductive or semi-conductive material having an electropolished finish.

In one aspect, the conductive material comprises a metal. Preferably the metal is selected from the group consisting of stainless steel, aluminum, iron, copper, tin, chromium, nickel and any alloys thereof.

In another aspect, the semi-conductive material comprises silicon.

Preferably the valve is made wholly of metal.

Preferably the valve is a metering valve.

In one aspect, the metal surfaces of the valve additionally comprise a friction-reducing coating.

Preferably the coating is selected from the group consisting of silicon oil and organic polymeric oil, or mixtures thereof.

In another aspect, the coating comprises a polymeric material. Preferably the polymeric material is selected from the group consisting of fluoropolymer and a copolymer of a fluoropolymer with another polymer.

In one aspect, the fluoropolymer is selected from the group consisting of polytetrafluoroethylene (PTFE), ethylenetetrafluoroethylene (ETFE), polyvinyldienefluoride (PVDF), perfluoroalkoxyalkane (PFA), polyvinylfluoride (PVF), polychlorotrifluoroethylene (PCTFE) and fluorinated ethylenepropylene (FEP).

In another aspect, the coating comprises a blend of fluoropolymer and a blend material selected from the group consisting of polyamides, polyimides, polyethersulfones, polyphenylene sulfides, and amine-formaldehyde thermosetting resins.

In a further aspect, the coating comprises a phosphate based perfluoroether derivative.

In one aspect, the coating comprises a silane derivative of perfluoropolyoxyalkane.

In another aspect, the coating comprises a siloxane polymer.

In another aspect of the present invention there is provided a valve stem for a valve for use in a dispenser for dispensing a medicament in a formulation, wherein the external surfaces of the valve stem comprise a conductive or semi-conductive material having an electropolished finish.

In a further aspect of the present invention there is provided a metering chamber for a valve for use in a dispenser for dispensing a medicament in a formulation, wherein the surfaces of said metering chamber comprise a conductive or semi-conductive material having an electropolished finish.

In yet another aspect of the present invention there is provided a metered dose inhaler comprising a dispenser according to the present invention and a medicament-channelling device. The surface of the medicament-channelling device may have an electropolished finish.

There is further provided by the present invention a method of finishing the surfaces of a canister for housing medicament and/or a drug dispensing mechanism of a dispenser for dispensing a medicament in a formulation comprising electropolishing said surfaces.

In one aspect, the mechanism is a drug-dispensing valve.

In another aspect, the valve is a metering valve.

Other forms of surface treatment may be utilized to smooth or deburr rough surfaces. These include electrochemical machining, electrochemical grinding and chemical polishing and thermal deburring. The later involves thermally removing burrs from the surface of an article by immersing the article in an atmosphere of combustible gases which are then ignited.

As with electropolishing, further mechanical processing is sometimes necessary with all of these treatments to introduce compressive stress into the surface and improve fatigue resistance. Other techniques, including electrolytic/chemical plating, may be used to deposit materials (e.g. diamond or PTFE in a metal matrix) onto the treated surfaces to improve wear resistance and/or frictional properties.

Medicaments which may be administered in the aerosol formulations include any drug useful in inhalation therapy. The dispenser of the invention is in one aspect suitable for dispensing medicament for the treatment of respiratory disorders such as disorders of the lungs and bronchial tracts including asthma and chronic obstructive pulmonary disorder (COPD).

The medicament dispenser of the invention is suitable for dispensing medicament, particularly for the treatment of respiratory disorders such as asthma and chronic obstructive pulmonary disease. Appropriate medicaments may thus be selected from, for example, analgesics, e.g., codeine, dihydromorphine, ergotamine, fentanyl or morphine; anginal preparations, e.g., diltiazem; antiallergics, e.g., cromoglycate (e.g. s the sodium salt), ketotifen or nedocromil (e.g. as the sodium salt); antiinfectives e.g., cephalosporins, penicillins, streptomycin, sulphonamides, tetracyclines and pentamidine; antihistamines, e.g., methapyrilene; antiinflammatories, e.g., beclomethasone (e.g. as the dipropionate ester), fluticasone (e.g. as the propionate ester), flunisolide, budesonide, rofleponide, mometasone e.g. as the furoate ester), ciclesonide, triamcinolone (e.g. as the acetonide) or 6α, 9α-difluoro-11β-hydroxy-16α-methyl-3-oxo-17α-propionyloxy-androsta-1,4-diene-17β-carbothioic acid S-(2-oxo-tetrahydro-furan-3-yl) ester; antitussives, e.g., noscapine; bronchodilators, e.g., albuterol (e.g. as free base or sulphate), salmeterol (e.g. as xinafoate), ephedrine, adrenaline, fenoterol (e.g. as hydrobromide), formoterol (e.g. as fumarate), isoprenaline, metaproterenol, phenylephrine, phenylpropanolamine, pibuterol (e.g. as acetate), reproterol (e.g. as hydrochloride), rimiterol, tebutaline (e.g. as sulphate), isoetharine, tulobuterol or 4-hydroxy-7-[2-[[2-[[3-(2-phenylethoxy)propyl]sulfoxyl]ethyl]amino]ethyl-2(3H)-bensothiazolone; adenosine 2a agonists, e.g. 2R,3R,4S,5R)-2-[6-Amino-2-(1S-hydroxymethyl-2-phenylethylamino)-purin-9-yl]-5-(2-ethyl-2H-tetrazol-5-yl)-tetrahydro-furan-3,4-diol (e.g. as maleate); α4 integrin inhibitors e.g. (2S)-3-[4-({[4-(aminocarbonyl)-1-piperidinyl]carbonyl}oxy)phenyl]-2-[((2S)-4-methyl-2-{[2-(2-methylphenoxy)acetyl]amino}pentanoyl)amino]propanoic acid (e.g. as free acid or potassium salt), diuretics, e.g., amiloride; anticholinergics, e.g., ipratropium (e.g. as bromide), tiotropium, atropine or oxitropium; hormones, e.g., cortisone, hydrocortisone or pendnisolone; xanthines, e.g., aminophylline, choline theophyllinate, lysine theophyllinate or theophylline; therapeutic proteins and peptides, e.g., insulin or glucagon; vaccines, diagnostics and gene therapies. It will be clear to a person skilled in the art that, where appropriated, the medicaments may be used in the form of salts, (e.g., as alkali metal or amine salts or as acid addition salts) or as esters (e.g., lower alkyl esters) or as solvates (e.g., hydrates) to optimise the activity and/or stability of the medicament and/or to minimise the solubility of the medicament in the propellant. Preferred medicaments are selected from albuterol, salmeterol, fluticasone propionate and beclomethansone dipropionate and salts or solvates thereof, e.g., the sulphate of albuterol and the xinafoate of salmeterol.

Medicaments can also be delivered in combinations. Preferred formulations containing combinations of active ingredients contain salbutamol (e.g., as the free base or the sulphate salt) or salmeterol (e.g., as the xinafoate salt) or formoterol (e.g. as the fumarate salt) in combination with an antiinflammatory steroid such as a beclomethasone ester (e.g., the dipropionate) or a fluticasone ester (e.g., the propionate) or budesonide. A particularly preferred combination is a combination of fluticasone propionate and salmeterol, or a salt thereof (particularly the xinafoate salt). A further combination of particular interest is budesonide and formoterol (e.g. as the fumarate salt).

Particularly preferred formulations for use in the canisters of the present invention comprise a medicament and a C₁₋₄hydrofluoroalkane particularly 1,1,1,2-tetrafluoroethane and 1,1,1,2,3,3,3-n-heptafluoropropane or a mixture thereof as propellant.

Preferred formulations are free or substantially free of formulation excipients. Thus, preferred formulations consist essentially of (or consist of) the medicament and the selected propellant.

Conventional bulk manufacturing methods and machinery well known to those skilled in the art of pharmaceutical aerosol manufacture may be employed for the preparation of large scale batches for the commercial production or filed canisters. Thus, for example, in one bulk manufacturing method a metering valve is crimped onto an aluminum can to form an empty canister. The particulate medicament is added to a charge vessel and liquefied propellant is pressure filled through the charge vessel in a manufacturing vessel. The drug suspension is made before recirculation to a filing machine and an aliquot of the drug suspension is then filled through the metering valve into the canister. Typically, in batches prepared for pharmaceutical use, each filled canister is check-weighed, coded with a batch number and packed into a tray for storage release testing.

Each filled canister is conveniently fitted into a suitable channelling device prior to use to form a metered dose inhaler for administration of the medicament into the lungs or nasal cavity of a patient. Suitable channelling devices comprise for example a valve actuator and a cylindrical or cone-like passage through which medicament may be delivered from the filled canister via the metering valve to the nose or mouth of a patient e.g. a mouthpiece actuator. Metered dose inhalers are designed to deliver a fixed unit dosage of medicament per actuation or “puffy”, for example in the range of 10 to 5000 microgram medicament per puff.

Administraton of medicament may be indicated for the treatment of mild, moderate or severe acute or chronic symptoms or for prophylactic treatment. It will be appreciated that the precise dose administered will depend on the age and condition of the patient, the particular particulate medicament used and the frequency of administration and will ultimately be at the discretion of the attendant physician. When combinations of medicaments are employed the dose of each component of the combination will in general be that employed for each component when used alone. Typically, administration may be one or more times, for example from 1 to 8 times per day, giving for example 1, 2, 3 or 4 puffs each time. Each valve actuation, for example, may deliver 5 μg, 50 μg, 100 μg, 200 μg or 250 μg of a medicament. Typically, each filled reservoir or canister for use in a metered dose inhaler contains 60, 100, 120 or 200 metered doses or puffs of medicament; the dosage of each medicament is either known or readily ascertainable by those skilled in the art.

A still further aspect of the present invention comprises a method of treating respiratory disorders such as, for example, asthma, which comprises administraton by inhalation of an effective amount of a medicament formulation as herein described from a dispenser of the present invention.

### BRIEF DESCRIPTION OF DRAWINGS

Embodiments of the invention will now be described with reference to the accompanying drawings in which:

FIG. 1. is a schematic representation of a valve herein.

FIG. 2. is a schematic representation of the interior surface of a dispensing valve.

FIG. 3. is a schematic representation of an electropolishing apparatus.

### DETAILED DESCRIPTION OF DRAWINGS

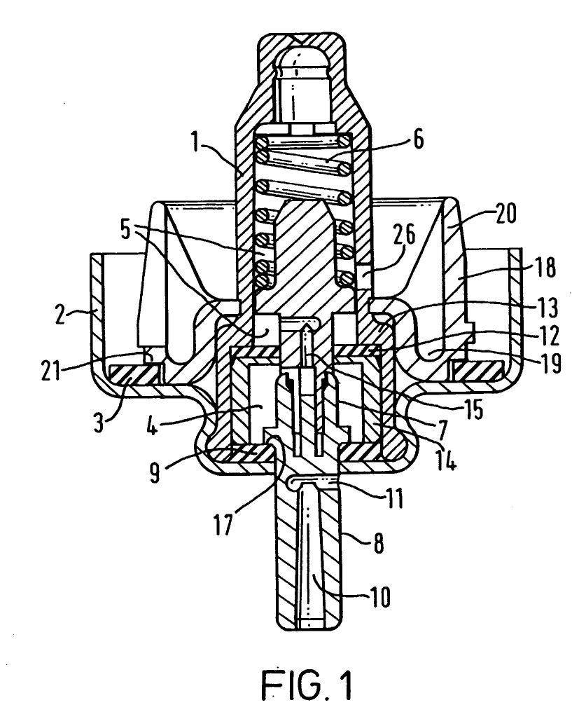

A valve according to the invention is shown in FIG. 1 and comprises a valve body 1 sealed in a ferrule 2 by mean s of crimping, the ferrule itself being set on the neck of a container (not shown) with interposition of a gasket 3 in a well-known manner. All parts of the valve, with the exception of the upper and lower stem seals 9 and 12, are comprised of a metal such as stain less steel.

The valve body 1 is formed at its lower part with a metering chamber 4, and it upper part with a sampling chamber 5 which also acts as a housing for a return spring 6. The words “upper” and “lower” are used for the container when it is in a use orientation with the neck of the container and valve at the lower end of the container which corresponds to the orientation of the valve as shown in FIG. 1. Inside the valve body 1 is disposed a valve stem 7, a part 8 of which extends outside the valve through lower stem seal 9 and ferrule 2. The stem part 8 is formed with an inner axial or longitudinal canal 10 opening at the outer end of the stem and in communication with a radial passage 11.

The upper portion of stem 7 has a diameter such that it can slide through an opening in an upper stem seal 12 and will engage the periphery of that opening sufficiently to provide a seal. Upper stem seal 12 is held in position against a step 13 formed in the valve body 1 between the said lower and upper parts by a sleeve 14 which defines the metering chamber 4 between lower stem seal 9 and upper stem seal 12. The valve stem 7 has a passage 15 which, when the stem is in the inoperative position shown, provides a communication between the metering chamber 4 and sampling chamber 5, which itself communicates with the interior of the container via orifice 26 formed in the side of the valve body 1.

Valve stem 7 is biased downwardly to the inoperative position by return spring 6 and is provided with a shoulder 17 which abuts against lower stem seal 9. In the inoperative position as shown in FIG. 1 shoulder 17 abuts against lower stem seal 9 and radial passage 11 opens below lower stem seal 9 so that the metering chamber 4 is isolated from canal 10 and suspension inside cannot escape.

A ring 18 having a “U” shaped cross section extending in a radial direction is disposed around the valve body below orifice 26 so as to form a trough 19 around the valve body. As seen in FIG. 1 the ring is formed as a separate component having an inner annular contacting rim of a diameter suitable to provide a friction fit over the upper part of valve body 1, the ring seating against step 13 below the orifice 26. However, the ring 18 may alternatively be formed as an integrally moulded part of valve body 1.

To use the device the container is first shaken to homogenise the suspension within the container. The user then depresses the valve stem 7 against the force of the spring 6. When the valve stem is depressed both ends of the passage 15 come to lie on the side of upper stem seal 12 remote from the metering chamber 4. Continued depression of the valve stem will move the radial passage 11 into the metering chamber 4 while the upper stem seal 12 seals against the valve stem body. Thus, the metered dose can exit through the radial passage 11 and the outlet canal 10.

Releasing the valve stem causes it to return to the illustrated position under the force of the spring 6. The passage 15 then once again provides communication between the metering chamber 4 and sampling chamber 6. Accordingly, at this stage liquid passes under pressure from the container through orifice 26, through the passage 15 and thence into the metering chamber 4 to fill it.

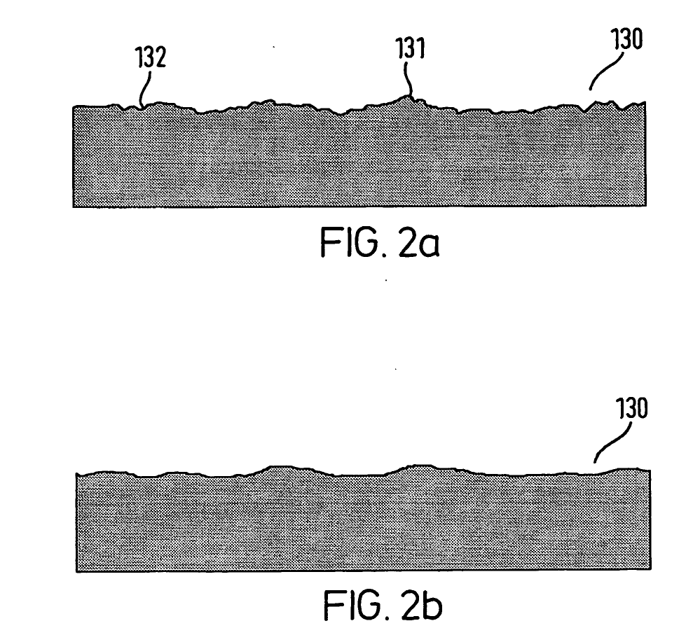

FIGS. 2a and 2b show schematic microscopic views of the internal surface 130 of a dispensing valve, such as that of FIG. 1, composed of stainless steel. FIG. 2a illustrates the rough and uneven nature of the surface 130 of the valve, with edges of burrs 131 and pits 132 evident. FIG. 2b depicts the surface 130 following electropolishing, illustrating a significant reduction in the number of edges or burrs 131 and pits 132 on the surface 130. The profile of surface 130 is significantly reduced following electropolishing.

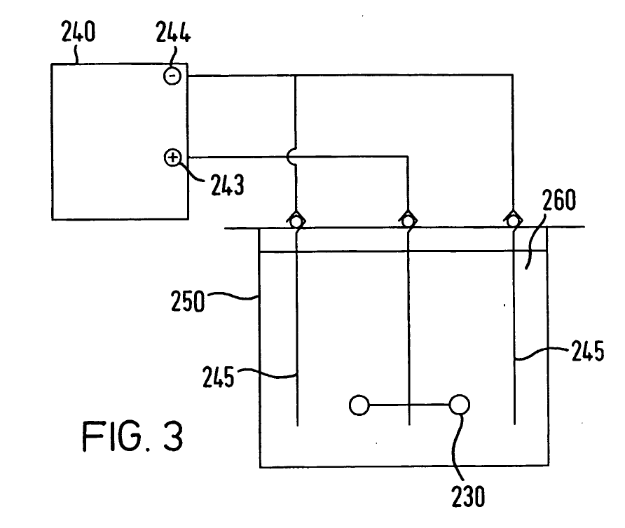

FIG. 3 depicts a schematic representation of the electropolishing tank 250 suitable for treatment of the internal surfaces and a reservoir/canister or valve of an inhalation device.

The surface 230 of the canister or valve which is to be finished by electropolishing is first descaled or degreased by appropriate solvents, prior to immersion in tank 250. The surface 230 is then exposed to the electrolytic solution 260 by submersion therein and is connected to the anode 243 of DC power supply 240. The negative terminal 244 is connected to a suitable conductor 245 which is also submerged in the solution 260. A direct current is applied from power supply 240 thereby forming a complete electrical circuit within the solution 260. The duration and amount of current applied may be varied depending upon the quantity of metal it is intended to remove from the surface 230 of the valve. A suitable amount of electricity is believed to be approximately 10 v current to approximately 1000 amps per square metre. The time will be varied depending upon the nature of the surface and the amount of polishing required. The valve may the be removed from the electropolishing tank 250, rinsed with a suitable liquid (for example tap water), then with a demineralised liquid (such as demineralised water) and dried. With stainless steel it is preferable that the work piece be quickly immersed in an oxidising agent and then rinsed in demineralised water prior to drying.

It will be understood that the present disclosure is for the purpose of illustration only and the invention extends to modifications, variations and imporvements thereto which will be within the ordinary skill of the person skilled in the art.

1. A dispenser for dispensing a medicament in a formulation comprising
(a) a reservoir for housing the medicament; and
(b) a drug-dispensing mechanism,
wherein the surfaces of said reservoir and/or said drug-dispensing mechanism comprise a conductive or semi-conductive material having an electropolished finish.

2. A dispenser according to claim 1, wherein the internal surfaces of the reservoir and/or drug-dispensing mechanism have an electropolished finish.

3. A dispenser according to any one of claims 1 or 2, wherein the electropolished finish is prepared by coating the surfaces in an electrolytic material and exposing the coated surfaces to an electric current.

4. A dispenser according to claim 3, wherein the electrolytic material is selected from the group consisting of phosphoric acid, sulphuric acid and cyanide solutions.

5. A dispenser according to any one of claims 1 to 4, wherein said conductive material comprises a metal.

6. A dispenser according to claim 5, wherein said metal is selected from the group consisting of stainless steel, aluminum, iron, copper, tin, chromium, nickel and any alloys thereof.

7. A dispenser according to any one of claims 1 to 4, wherein said semiconductive material comprises silicon.

8. A dispenser according to any of claims 1 to 6, wherein said drug-dispensing mechanism and/or said reservoir is/are made wholly of metal.

9. A dispenser according to any of claims 1 to 8, wherein the drug-dispensing mechanism comprises a valve.

10. A dispenser according to claim 9, wherein said valve is a metering valve.

11. A dispenser according to any of claims 1 to 10, wherein the surfaces of the drug dispensing mechanism comprise a friction-reducing coating.

12. A dispenser according to claim 11, wherein said coating is selected from the group consisting of silicon oil and organic polymeric oil, or mixtures thereof.

13. A dispenser according to claim 11, wherein the coating comprises a polymeric material.

14. A dispenser according to claim 13, wherein the polymeric material comprises a fluoropolymer.

15. A dispenser according to claim 14, wherein said polymeric material is selected from the group consisting of fluoropolymer and a copolymer of a fluoropolymer with another polymer.

16. A dispenser according to any one of claim 14 or claim 15, wherein the fluoropolymer is selected from the group consisting of polytetrafluoroethylene (PTFE), ethylenetetrafluoroethylene (ETFE), polyvinyldienefluoride (PVDF), perfluoroalkoxyalkane (PFA), polyvinylfluoride (PVF), polychlorotrifluoroethylene (PCTFE) and fluorinated ethylenepropylene (FEP).

17. A dispenser according to claim 14, where in the fluoropolymer comprises a functional grouping which is capable of anchoring the fluoropolymer to the surface of the surface of the drug-dispensing mechanism.

18. A dispenser according to claim 17, wherein the fluoropolymer is a perfluoroorganophosphate.

19. A dispenser according to claim 18, wherein the perfluoroorganophosphate is a compound of formula (I)
R¹—(CH₂)ᵥ—CF₂O—(C₂F₄O)ₓ—(CF₂O)_{y}CF₂—(CH₂)_{w}—R¹ (I)
wherein R¹ comprises:
—(OCH₂—CH₂)_{z}—OPO(OH)₂, wherein x, y and z are such that the molecular weight of the compound is 900-2100 and v and w independently represent 1 or 2.

20. A dispenser according to claim 19, wherein v and w are both 1.

21. A dispenser according to claim 19, wherein v and w are both 2.

22. A dispenser according to claim 17, wherein the fluoropolymer comprises a compound of formula (II)
R²—(OC₃F₆)ᵣ—(OCF₂)ₜ—R³ (II)
wherein R² comprises a fluoro-alkyl functional group;
r and t are such that the molecular weight of the compound is 350-1000; and
R³ comprises a phosphoric ester functional group.

23. A dispenser according to claim 17, wherein the fluoropolymer is an organosilane derivative.

24. A dispenser according to claim 13, wherein the polymeric material comprises a silane derivative of perfluoropolyoxyalkane.

25. A dispenser according to claim 13, wherein the polymeric material comprises a siloxane polymer.

26. A dispenser according to any one of claims 14 or 25, wherein the coating comprises a blend of fluoropolymer and a blend material selected from the group consisting of polyamides, polyimides, polyethersulphones, polyphenylene sulphides, and amine-formaldehyde thermosetting resins.

27. A dispenser according to claim 26, wherein the polymer blends are selected from the group consisting of PTFE/FEP/polyamideimide, PTFE/polyethersulphone and FEP/benzoguanamine.

28. A dispenser as claimed in any one of the preceding claims comprising a medicament in a fluid propellant, wherein the fluid propellant includes a hydrofluoroalkane.

29. A dispenser according to claim 28, wherein said hydrofluoroalkane is selected from the group consisting of 1,1,1,2-tetrafluorethane, 1,1,1,2,3,3,3,-heptafluoropropane; and any mixtures thereof.

30. A dispenser according to either of claims 28 or 29, additionally comprising solvent at a level of 0.01% to 5% w/w of the fluid propellant.

31. A dispenser according to claim 30, wherein said solvent is ethanol.

32. A dispenser according to any of claims 1 to 27, suitable for dispensing a medicamnent in a dry powder formulation.

33. A dispenser according to any of claims 1 to 27, suitable for dispensing a medicament in an aqueous formulation.

34. A valve for use in a dispenser for dispensing a medicament in a fluid propellant, wherein the surfaces of said valve comprises a conductive or semi-conductive material having an electropolished finish.

35. A valve according to claim 34, wherein said conductive material comprises a metal.

36. A valve according to claim 35, wherein said metal is selected from the group consisting of stainless steel, aluminum, iron, copper, tin, chromium, nickel and any alloys thereof.

37. A valve according to claim 34, wherein said semi-conductive material comprises silicon.

38. A valve according to any of claims 34 to 37, wherein the valve is made wholly of metal.

37. A valve according to claim 38, wherein said valve is a metering valve.

40. A valve according to any of claims 34 to 39, wherein said surfaces comprise a friction-reducing coating.

41. A valve according to claim 40, wherein said coating is selected from the group consisting of silicon oil and organic polymeric oil, or mixtures thereof.

42. A valve according to claim 40, wherein the coating comprises a polymeric material.

43. A valve according to claim 42, wherein the polymeric material comprises a fluoropolymer.

44. A valve according to claim 42 or 43, wherein said polymeric material is selected from the group consisting of fluoropolymer and a copolymer of a fluoropolymer with another polymer.

45. A valve according to claim 43 or 44, wherein the fluoropolymer is selected from the group consisting of polytetrafluoroethylene (PTFE), ethylenetetrafluoroethylene (ETFE), polyvinyldienefluoride (PVDF), perfluoroalkoxyalkane (PFA), polyvinylfluoride (PVF), polychlorotrifluoroethylene (PCTFE) and fluorinated ethylenepropylene (FEP).

46. A valve according to claim 43, wherein the fluoropolymer comprises a functional grouping which is capable of anchoring the fluoropolymer to the surface of the valve.

47. A valve according to claim 46, wherein the fluoropolymer is a perfluoroorganophosphate.

48. A valve according to claim 47, wherein the perfluoroorganophosphate is a compound of formula (I)
R¹—(CH₂)ᵥ—CF₂O—(C₂F₄O)ₓ—(CF₂O)_{y}CF₂—(CH₂)_{w—R}¹ (I)
wherein R¹ comprises:
—(OCH₂—CH₂)_{z}—OPO(OH)₂ wherein x, y and z are such that the molecular weight of the compound is 900-2100 and v and w independently represent 1 or 2.

49. A dispenser according to claim 48, wherein v and w are both 1.

50. A dispenser according to claim 48, wherein v and w are both 2.

51. A dispenser according to claim 46, wherein the fluoropolymer comprises a compound of formula (II)
R²—(OC₃F₆)ᵣ—(OCF₂)ₜ—R³ (II)
wherein R² comprises a fluoro-alkyl functional group;
r and t are such that the molecular weight of the compound is 350-1000; and
R³ comprises a phosphoric ester functional group.

52. A dispenser according to claim 46, wherein the fluoropolymer is an organosilane derivative.

53. A dispenser according to claim 42, wherein the polymeric material comprises a silane derivative of perfluoropolyoxyalkane.

54. A dispenser according to claim 42, wherein the polymeric material comprises a siloxane polymer.

55. A valve according to any one of claims 43 to 54, wherein the coating comprises a blend of fluoropolymer and a blend material selected from the group consisting of polyamides, polyimides, polyethersulfones, polyphenylene sulfides, and amine-formaldehyde thermosetting resins.

56. A valve according to claim 55, wherein the polymer blends are selected from the group consisting of PTFE/FEP/polyamideimide, PTFE/polyethersulphone and FEP/benzoguanamine.

57. A valve stem for a valve for use in a dispenser for dispensing a medicament in a formulation, wherein the external surfaces of said valve stem comprises a conductive or semi-conductive material having an electropolished finish.

58. A metering chamber for a valve for use in a dispenser for dispensing a medicament in a formulation, wherein the surfaces of said metering chamber comprise a conductive or semi-conductive material having a electropolished finish.

59. A metered dose inhaler comprising a dispenser according to any one of claims 1 to 33 and a medicament-channelling device.

60. A method of finishing the surfaces of a reservoir for housing medicament and/or a drug dispensing mechanism of a dispenser for dispensing a medicament in a fluid propellant comprising electropolishing said surfaces.

61. A method according to claim 60, wherein the electropolishing comprises coating the surfaces in an electrolytic material and exposing the coated surfaces to an electric current.

62. A method according to claim 61, wherein the electrolytic material is selected from the group consisting of phosphoric acid, sulphuric acid and cyanide solutions.

63. A method according to any one of claims 60 to 62, wherein said mechanism is a valve.

64. A method according to claim 63, wherein said valve is a metering valve.
